(19) United States
(12) Patent Application Publication
(10) Pub. No.: US 2013/0220813 A1
(43) Pub. Date: Aug. 29, 2013

(54) ARTICLES AND METHODS FOR MODIFYING CONDENSATION ON SURFACES

(71) Applicants: Sushant Anand, Somerville, MA (US); Adam T. Paxson, Cambridge, MA (US); Jonathan David Smith, Cambridge, MA (US); Kripa K. Varanasi, Lexington, MA (US)

(72) Inventors: Sushant Anand, Somerville, MA (US); Adam T. Paxson, Cambridge, MA (US); Jonathan David Smith, Cambridge, MA (US); Kripa K. Varanasi, Lexington, MA (US)

(73) Assignee: MASSACHUSETTS INSTITUTE OF TECHNOLOGY, Cambridge, MA (US)

(21) Appl. No.: 13/495,931

(22) Filed: Jun. 13, 2012

Related U.S. Application Data
(60) Provisional application No. 61/605,133, filed on Feb. 29, 2012.

(51) Int. Cl. B32B 33/00; B05D 5/00; C25D 13/00

(52) U.S. Cl. 204/471; 428/141; 428/143; 204/622; 427/256

(57) ABSTRACT

The articles and methods described herein provide a way to manipulate condensation on a surface by micro/nano-engineering textures on the surface and filling the spaces between the texture features with an impregnating liquid that is stably held therebetween or therewithin. The articles and methods allow droplets of water, or other condensed phases, even in micrometer size range, to easily shed from the surface, thereby enhancing contact between a condensing species and the condensing surface. It has been found that dropwise condensation is enhanced by the use of an impregnating (secondary) liquid that has a relatively high surface tension, and, even more preferably, an impregnating liquid that has both a high surface tension and a low viscosity.

### RELATED APPLICATION

This application claims priority to and the benefit of, and incorporates herein by reference in its entirety, U.S. Provisional Patent Application No. 61/605,133, which was filed on Feb. 29, 2012.

### TECHNICAL FIELD

This invention relates generally to articles and methods that enhance or inhibit droplet shedding from surfaces. More particularly, in certain embodiments, articles and methods are provided for manipulating condensation on a surface by encapsulating or impregnating a secondary liquid in micro or nano-scale textures of the surface.

### BACKGROUND

Vapor condenses upon a surface if the surface is cooled below the saturation temperature at a given pressure. The condensing phase may grow on the surface as a liquid film and/or as droplets or islands of liquid. Condensation is useful in many industrial applications, although in certain applications, it is useful to inhibit or prevent the filmwise buildup of condensating liquid on a surface by promoting droplet shedding.

For applications where condensation is desired, the formation of a film (i.e., filmwise condensation) may be detrimental as the film may act as a thermal barrier for heat transfer between the condensing surface and the condensing species. To overcome this limitation, surfaces may be modified such that the condensed phase grows on the surface in the form of droplets or islands (i.e., dropwise condensation). Under dropwise condensation, the droplets coalesce and shed periodically, leaving large bare surfaces in contact with condensing species, thereby providing heat transfer coefficients that are two to ten times greater than with filmwise condensation. Under the dropwise mechanism of condensation, high heat fluxes of 170-300 kW/m² can be achieved.

The modification of surfaces to promote dropwise condensation has been implemented using, for example, coatings (e.g., dioctadecyldisulphide or oleic acid), ion implantation techniques, and textured surfaces with micro/nanostructures. A common objective for such modifications is to promote formation of droplets on the condensing surface with large contact angles. For example, superhydrophobic surfaces obtained using surfaces textured with nano/microstructures may minimize contact line pinning. Referring to FIG. 1a, millimetric drops 101 that come into contact with the textured surface (e.g., with the peaks or post tops 102 of the surface) may be shed easily, with minimal adhesion. However, even on surfaces exhibiting large contact angles, a condensed phase (e.g., water) may not shed easily as a contact line may be pinned to the surface. For example, referring to FIG. 1b, condensing droplets may form in a Wenzel state (e.g., with the condensed phase 104 impaled beneath the peaks or post tops 102 of the surface) in which depinning of droplets is not easily achievable and, as a result, droplets do not shed easily.

There is a need for improved articles and methods for manipulating (e.g., promoting or inhibiting) condensation on a surface. For example, there is a need for robust surfaces that promote dropwise condensation with minimal pinning of droplets.

### SUMMARY OF THE INVENTION

The articles and methods described herein provide a way to manipulate condensation on a surface by micro/nano-engineering textures on the surface and filling the spaces between the texture features with an impregnating liquid that is stably held therebetween or therewithin. The articles and methods allow droplets of water, or other condensed phases, e.g., even in the micrometer size range, to easily shed or exude from the surface, thereby enhancing the heat transfer coefficient of the surface. It has been found that dropwise condensation is enhanced by the use of a surface textured with micro and/or nanostructures and having an impregnating (secondary) liquid with a relatively high surface tension, and, even more preferably, an impregnating liquid with both a high surface tension and a low viscosity.

Furthermore, in certain embodiments, thermodynamic conditions at which condensation occurs can be manipulated by application of an electric field on the impregnated surface or in the encapsulating secondary liquid.

The articles and methods have applications in a wide variety of devices that involve condensation, including condensers, aircraft wings, blades, turbines, pipelines, humidifiers, dehumidifiers, fog harvesters and collectors, and the like.

Referring to FIG. 1c, in certain embodiments, the articles and methods manipulate condensation on a surface by including a secondary liquid 106 impregnated within (i.e., encapsulating) the surface textures. The secondary liquid encapsulates the surface textures, thereby preventing a condensed phase from attaining the Wenzel state. Since liquids, unlike gases, are incompressible over a large range of pressures, impalement of a condensed phase can be prevented even with relatively large microtextures, without requiring nano-scale textures, as utilized with previous, non-encapsulated or non-impregnated surfaces. In addition, the secondary layer greatly increases droplet mobility of the condensed phase. The increased mobility of condensed droplets on the secondary liquid allows the droplets to shed easily from the surface. Unlike previous superhydrophobic surfaces, which require high droplet contact angles, the high droplet mobility achieved with the surfaces described herein is independent of the droplet contact angle. Furthermore, in various embodiments, the temperature at which the condensed phase may form on the surface is manipulated by application of an electric field on the impregnated surface or in the encapsulating secondary liquid. As a result, dropwise condensation can be induced at temperatures above saturation temperature for a given pressure, and the rate of dropwise condensation and/or droplet shedding can be enhanced significantly at a given subcooling temperature.

In one aspect, the invention is directed to an article including a liquid-impregnated surface configured to promote or inhibit condensation thereupon and/or shedding of condensate thereupon, said surface including a matrix of features and an impregnating liquid, said features spaced sufficiently close to stably contain an impregnating liquid therebetween or therewithin. In one embodiment, the surface tension of impregnating (secondary) liquid is such that the impregnating liquid does not spread on the condensing phase (primary liquid, i.e., condensate) and the condensing phase does not spread and form film on the impregnating liquid. Thermodynamically, this limit is given by:

(γ_{wa}−γ_{ow})<γₒₐ<(γ_{wa}+γ_{ow}) (1)

where γ_{wa} is surface tension of primary liquid with respect to air, γₒₐ is surface tension of impregnating liquid with respect to air, and γ_{ow} is surface tension of impregnating (secondary) liquid with respect to primary liquid.

In certain embodiments, the surface is configured to promote condensation and/or shedding of condensate thereupon, and wherein the impregnating liquid has a surface tension from about 30% to about 95% of the surface tension of the condensate. In certain embodiments, the impregnating liquid has a surface tension from about 33% to about 67% of the surface tension of the condensate. In certain embodiments, the condensate is water. In certain embodiments, the surface tension of the impregnating liquid is from about 24 dynes/cm to about 49 dynes/cm. In certain embodiments, the impregnating liquid is (or contains) Krytox-1506, ionic liquid (e.g., BMI-IM), tetradecane, pentadecane, cis-decalin, alpha-bromonaphthalene, alpha-chloronapthalene, Ethyl Oleate, o-bromotoluene, diiodomethane, tribromohydrin, Phenyl Mustard Oil, Acetylene tetrabromide, and/or EMI-Im (CₐH₁₁F₆N₃O₄S₂). In certain embodiments, the impregnating liquid has viscosity no greater than about 500 cP. In certain embodiments, the impregnating liquid has viscosity no greater than about 100 cP. In certain embodiments, the impregnating liquid has viscosity no greater than about 50 cP. In certain embodiments, the matrix of features comprises hierarchical structures. For example, in certain embodiments, the hierarchical structures are micro-scale features that comprise nano-scale features thereupon. It is contemplated that features of the liquid-impregnated surfaces described in the Appendix attached hereto, are, in certain embodiments, additionally included in the liquid-impregnated surfaces of the articles above.

In another aspect, the invention is directed to a method for enhancing condensation and/or shedding of a condensate upon a surface, the method including impregnating the surface with an impregnating liquid, said surface including a matrix of features and an impregnating liquid, said features spaced sufficiently close to stably contain the impregnating liquid therebetween or therewithin. In certain embodiments, the method further includes applying an electric field or electric flux to at least a portion of the surface to enhance condensation and/or shedding of condensate. In certain embodiments, the surface is one of the liquid-impregnated surfaces described above.

In another aspect, the invention is directed to an article including a liquid-impregnated surface configured to promote or inhibit condensation thereupon and/or shedding of condensate thereupon, said surface including a matrix of features on a solid substrate and an impregnating liquid, said features spaced sufficiently close to stably contain an impregnating liquid therebetween or therewithin, in any orientation. In certain embodiments, the impregnating liquid has a surface tension with respect to air, γₒₐ, such that: (γ_{wa}−γ_{ow})<γₒₐ<(γ_{wa}+γ_{ow}), where γ_{wa} is surface tension of the condensate with respect to air or other surrounding gas, γₒₐ is surface tension of the impregnating liquid with respect to air or other surrounding gas, and γ_{ow} is interfacial tension between the impregnating liquid and the condensate. In certain embodiments, one or more of expressions (a) through (d) holds:

(γ_{wa}−γ_{ow})<γₒₐ<(γ_{wa}+γ_{ow}); (a)

γₒₛ/γ_{ws}<[1+(γ_{ow}/γ_{ws})((r−1)/(r−φ))]; (b)

γₒₐ/γ_{wa}>[1−γ_{ow}/γ_{wa}]; and (c)

γₒₐ/γ_{wa}<[1+γ_{ow}/γ_{wa}], (d)

where γ_{wa} is surface tension of the condensate with respect to air or other surrounding gas, γₒₐ is surface tension of the impregnating liquid with respect to air or other surrounding gas, γ_{ow} is interfacial tension between the impregnating liquid and the condensate, γₒₛ is interfacial tension between the impregnating liquid and the solid substrate, γ_{ws} is interfacial tension between the condensate and the solid substrate, r is ratio of actual surface area of the solid substrate to projected area of the solid substrate, and φ is fraction of the surface area of the solid substrate that touches the condensate. In certain embodiments, all of (a), (b), (c), and (d) holds such that the impregnating liquid does not spread on the condensate, the condensate does not displace the impregnating liquid, and the condensate does not spread on the impregnating liquid in filmwise condensation. In certain embodiments, the surface is configured to promote condensation and/or shedding of condensate thereupon, and wherein the impregnating liquid has a surface tension from about 30% to about 95% of the surface tension of the condensate. In certain embodiments, the impregnating liquid has a surface tension from about 33% to about 67% of the surface tension of the condensate. In certain embodiments, the condensate is water. In certain embodiments, the surface tension of the impregnating liquid is from about 24 dynes/cm to about 49 dynes/cm. In certain embodiments, the impregnating liquid comprises at least one member selected from the group consisting of Krytox-1506, ionic liquid (e.g., BMI-IM), tetradecane, pentadecane, cis-decalin, alpha-bromonaphthalene, alpha-chloronapthalene, diiodomethane, Ethyl Oleate, o-bromotoluene, diiodomethane, tribromohydrin, Phenyl Mustard Oil, Acetylene tetrabromide, and EMI-Im (C₈H₁₁F₆N₃O₄S₂). In certain embodiments, the impregnating liquid has viscosity no greater than about 500 cP. In certain embodiments, the impregnating liquid has viscosity no greater than about 100 cP. In certain embodiments, the impregnating liquid has viscosity no greater than about 50 cP. In certain embodiments, the impregnating liquid has vapor pressure at room temperature no greater than about 20 mm Hg. In certain embodiments, the matrix of features comprises hierarchical structures. In certain embodiments, the hierarchical structures are micro-scale features that comprise nano-scale features thereupon. In certain embodiments, the features have substantially uniform height and wherein the impregnating liquid fills space between the features and coats the features with a layer at least about 5 nm in thickness over the top of the features. In certain embodiments, the features define pores or other wells and wherein the impregnating liquid fills the features. In certain embodiments, the impregnating liquid forms a stable thin film on top of the features. In certain embodiments, the matrix has a feature-to-feature spacing from about 1 micrometer to about 100 micrometers. In certain embodiments, the features comprise at least one member selected from the group consisting of posts, particles, nanoneedles, nanograss, and random geometry features. In certain embodiments, the article comprises a plurality of spaced-apart electrodes configured for imposing an electric field or an electric flux to the liquid-impregnated surface. In certain embodiments, the article is a condenser. In certain embodiments, the solid substrate comprises one or more members selected from the group consisting of a hydrocarbon, a polymer, a fluoropolymer, a ceramic, glass, fiberglass, and a metal. In certain embodiments, the solid substrate is a coating. In certain embodiments, the solid substrate is intrinsically hydrophobic.

In another aspect, the invention is directed to a method for enhancing condensation and/or shedding of a condensate (primary liquid) upon a surface, the method including impregnating the surface with an impregnating liquid (secondary liquid), said surface including a matrix of features on a solid substrate and the impregnating liquid, said features spaced sufficiently close to stably contain the impregnating liquid therebetween or therewithin, in any orientation. In certain embodiments, the surface is configured and/or the impregnating liquid is chosen such that one or more of expressions (a) through (d) holds:

(γ_{wa}−γ_{ow})<γₒₐ<(γ_{wa}+γ_{ow}); (a)

γₒₛ/γ_{ws}<[1+(γ_{ow}/γ_{ws})((r−1)/(r−φ))]; (b)

γₒₐ/γ_{wa}>[1−γ_{ow}/γ_{wa}]; and (c)

γₒₐ/γ_{wa}<[1+γ_{ow}/γ_{wa}], (d)

where γ_{wa} is surface tension of the condensate with respect to air or other surrounding gas, γₒₐ is surface tension of the impregnating liquid with respect to air or other surrounding gas, γ_{ow} is interfacial tension between the impregnating liquid and the condensate, γₒₛ is interfacial tension between the impregnating liquid and the solid substrate, γ_{ws} is interfacial tension between the condensate and the solid substrate, r is ratio of actual surface area of the solid substrate to projected area of the solid substrate, and φ is fraction of the surface area of the solid substrate that touches the condensate. In certain embodiments, all of (a), (b), (c), and (d) holds such that the secondary liquid does not spread on the primary liquid, the primary liquid does not displace the secondary liquid, and the primary liquid does not spread on the secondary liquid in filmwise condensation. In certain embodiments, the secondary liquid is chosen such that the spreading coefficient S of the secondary liquid on the primary liquid is negative. where S=γ_{wa}−γ_{oa-γ}_{ow}, where γ_{wa} is surface tension of the condensate with respect to air or other surrounding gas, γₒₐ is surface tension of the impregnating liquid with respect to air or other surrounding gas, and γ_{ow} is interfacial tension between the impregnating liquid and the condensate. In certain embodiments, the secondary liquid is chosen such that the secondary liquid has partial miscibility with the primary liquid such that the surface tension of a primary phase consisting essentially of the primary liquid is reduced and the spreading coefficient S is negative. In certain embodiments, the method further includes applying an electric field or electric flux to at least a portion of the surface. In certain embodiments, the method includes applying the electric field or electric flux via a plurality of spaced-apart electrodes, wherein the electrodes are spread apart to disseminate a charge throughout the impregnating liquid. In certain embodiments, the surface is the liquid-impregnated surface of the article of any one of the above-described embodiments.

Elements of embodiments described with respect to a given aspect of the invention may be used in various embodiments of another aspect of the invention. For example, it is contemplated that features of dependent claims depending from one independent claim can be used in apparatus and/or methods of any of the other independent claims.

### BRIEF DESCRIPTION OF THE DRAWINGS

The objects and features of the invention can be better understood with reference to the drawing described below, and the claims.

FIG. 1a is a schematic view of a primary liquid (e.g., a condensed phase) on a solid surface (e.g., a superhydrophobic surface) in a Cassie state in which the primary liquid sits on top of microstructures, according to an illustrative embodiment of the invention.

FIG. 1b is a schematic view of a primary liquid (e.g., a condensed phase) on a solid surface (e.g., a superhydrophobic surface) in a Wenzel state in which liquid may nucleate substantially everywhere on the surface and a large droplet remains in an impaled state, according to an illustrative embodiment of the invention.

FIG. 1c is a schematic view of a primary liquid (e.g., a condensed phase) on a solid surface (e.g., a superhydrophobic surface) with a secondary liquid impregnated into surface textures of the solid surface, to prevent impalement and pinning of the primary liquid within microtextures, according to an illustrative embodiment of the invention.

FIG. 2 is an SEM (Scanning Electron Microscope) image of an ionic liquid-impregnated, OTS-treated silicon micro-post array with dry post tops, as indicated by the presence of a nonwetting droplet of the ionic liquid on a post top, according to an illustrative embodiment of the invention.

FIG. 3 includes a sequence of ESEM (Environmental Scanning Electron Microscope) images of condensation of water vapor on a superhydrophobic surface having an array of hydrophobic square posts with a width, edge-to-edge spacing, and aspect ratio of 10 μm, 10 μm, and 1, respectively, according to an illustrative embodiment of the invention.

FIG. 4 is an example guide for choosing a secondary liquid in relation to the primary liquid for a particular solid surface. This regime map relates the surface energies of oil, water and the solid surface and based on their ratios predicts the state in which a suspended droplet of primary liquid would remain on the encapsulated surface.

FIG. 5 includes a sequence of photographs depicting dropwise condensation on surfaces impregnated with two types of secondary liquids, according to an illustrative embodiment of the invention.

FIG. 6 is an ESEM image of water droplets that did not evaporate under 50% relative humidity, likely because the droplets were covered by a thin film of secondary liquid, according to an illustrative embodiment of the invention.

FIG. 7a is a plot comparing a fraction of surface covered by condensed water droplets on surfaces impregnated with two types of secondary liquids, according to an illustrative embodiment of the invention.

FIG. 7b is a plot comparing number of water droplets per unit area for OTS-treated silicon micro-post array surfaces impregnated with two types of secondary liquids, according to an illustrative embodiment of the invention.

FIG. 8 is a sequence of images depicting condensation of droplets on an ionic liquid-impregnated, OTS-treated silicon micro-post array, according to an illustrative embodiment of the invention.

FIG. 9a is an SEM image of an ionic liquid-impregnated, OTS-treated silicon micro-post array with dry post tops, as indicated by the presence of a nonwetting droplet of the ionic liquid (BMI-IM) on a post top, according to an illustrative embodiment of the invention.

FIG. 9b is an SEM image of an OTS-treated, nano-textured micropost surface fully encapsulated by the ionic liquid, according to an illustrative embodiment of the invention.

FIG. 10 is a sequence of images depicting condensation of droplets on a nano-textured micropost array fully encapsulated by an ionic liquid, according to an illustrative embodiment of the invention.

FIG. 11a is a plot of droplet velocities with respect to the droplet size for three different samples—Plain Gold sample; square micro-post (SMP) array surfaces impregnated with secondary liquid which forms suspended dropwise; and nano-textured micropost (NG-SMP) array impregnated with secondary liquid which forms suspended dropwise, according to an illustrative embodiment of the invention.

FIG. 11b is a plot which shows how different sized droplets move on the nano-textured micropost (NG-SMP) array impregnated with secondary liquid which forms suspended dropwise, according to an illustrative embodiment of the invention. The Primary Y-axis shows the angles taken by different sized droplets with 0 degree signifies along the gravity and 180 degree signifies droplet movement opposite the gravity direction. The secondary axis shows displacement time (droplet diameter/droplet velocity) giving time taken by each droplet to move distance relative to its size. Shorter displacement times signify that droplets have higher mobility.

FIG. 12 includes images of preferential condensation of droplets on a micro-textured surface impregnated by an ionic liquid and exposed to an electron flux or current, according to an illustrative embodiment of the invention.

FIG. 13 includes a sequence of images depicting condensation of droplets on an ionic liquid-impregnated, OTS-treated silicon micro-post array, according to an illustrative embodiment of the invention.

FIG. 14 includes two sequences of images depicting condensation of droplets on an ionic liquid-impregnated, OTS-treated silicon micro-post array, exposed to an electron beam, according to an illustrative embodiment of the invention.

FIG. 15a is a plot that shows region of influence where condensed droplets are formed for different electron beam voltages droplets on an ionic liquid-impregnated, OTS-treated silicon micro-post array, according to an illustrative embodiment of the invention.

FIG. 15b is a plot that shows size variation of condensed droplets along the radial distance from the point of focus of electron beam on ionic liquid-impregnated, OTS-treated silicon micro-post array, exposed to an electron beam (15 kV and 1.7 nA), according to an illustrative embodiment of the invention.

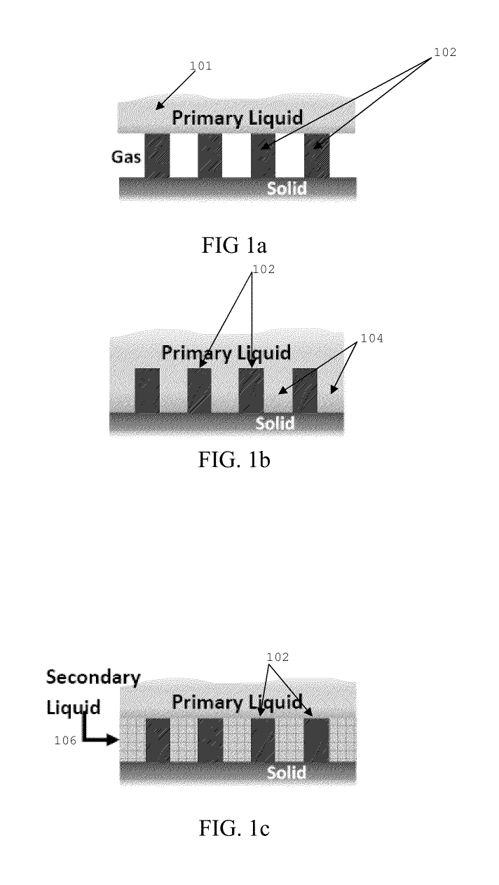

### DESCRIPTION

It is contemplated that apparatus, articles, methods, and processes of the claimed invention encompass variations and adaptations developed using information from the embodiments described herein. Adaptation and/or modification of the apparatus, articles, methods, and processes described herein may be performed by those of ordinary skill in the relevant art.

Throughout the description, where apparatus and articles are described as having, including, or comprising specific components, or where processes and methods are described as having, including, or comprising specific steps, it is contemplated that, additionally, there are apparatus and articles of the present invention that consist essentially of, or consist of, the recited components, and that there are processes and methods according to the present invention that consist essentially of, or consist of, the recited processing steps.

It should be understood that the order of steps or order for performing certain actions is immaterial so long as the invention remains operable. Moreover, two or more steps or actions may be conducted simultaneously.

The mention herein of any publication, for example, in the Background section, is not an admission that the publication serves as prior art with respect to any of the claims presented herein. The Background section is presented for purposes of clarity and is not meant as a description of prior art with respect to any claim.

Liquid impregnated surfaces are described in U.S. patent application Ser. No. 13/302,356, entitled “Liquid-Impregnated Surfaces, Methods of Making, and Devices Incorporating the Same,” the disclosure of which is hereby incorporated by reference herein in its entirety.

In certain embodiments, micro-scale features are used (e.g., from 1 micron to about 100 microns in characteristic dimension). In certain embodiments, nano-scale features are used (e.g., less than 1 micron, e.g., 1 nm to 1 micron).

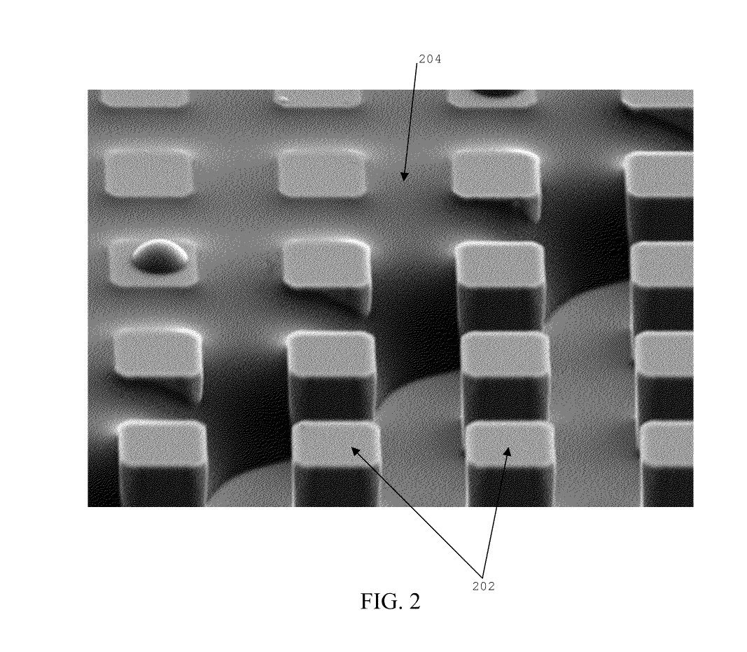

Referring to FIG. 2, in one experimental example, a microtextured surface was encapsulated or impregnated with an ionic liquid. The surface was made of silicon and included a square pattern of 10 μm posts 202 spaced 10 μm apart, and was pre-treated with octadecyltrichlorosilane (OTS). The encapsulation was performed by depositing and spreading a droplet of ionic liquid and then allowing the excess ionic liquid to drain from the surface via gravity. As depicted, a meniscus profile 204 of the ionic liquid is clearly visible. The encapsulation was quite robust as the liquid adhered to the surface strongly and did not escape even after being sprayed with water jets under a faucet. In other embodiments, the secondary liquid can be encapsulated in the microtextured surface using other method such as dip coating, spin coating, spray coating etc.

As mentioned, a previous approach to promoting dropwise condensation utilizes superhydrophobic surfaces, which reduce the contact area between the condensed phase and the superhydrophobic surface. Specifically, the condensed phase may rest on top of the micro/nano surface textures, leaving air entrapped beneath the condensed droplets, thereby decreasing adhesion between the droplets and the condensing surface. However, in actual applications, superhydrophobic surfaces possess many limitations.

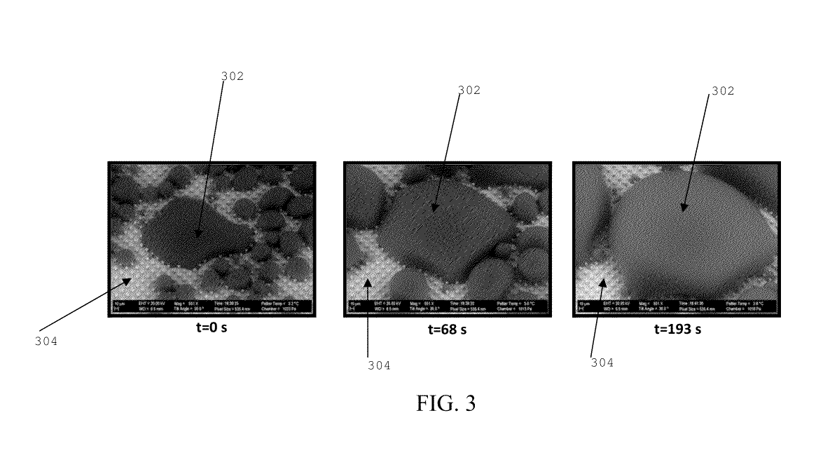

For example, during nucleation, a liquid or vapor phase is transformed into a condensed phase (liquid or solid) on an underlying surface. This transformation involves a transition of molecules from one phase to another and thus the initiation of nucleation may begin at nanometer scales. In certain embodiments, the droplets that nucleate on the surface are usually much smaller than a feature size (e.g., a length scale of posts or pores on the surface) of the nano/micro structures of the superhydrophobic surface. Upon further condensation, the droplets grow in a state where they may become or remain in an impaled state with respect to the surface structures. Thus, referring to FIG. 3, a surface that exhibits a Cassie-Baxter regime when a pre-existing droplet is introduced on its surface may exhibit droplets in a Wenzel regime during condensation. In various embodiments, a consequence of attaining the Wenzel regime during condensation on superhydrophobic surfaces is that there is marked increase in the hysteresis of such droplets and consequently a decrease in their ability to shed from the surface. The surface depicted in FIG. 3 was treated with fluorosilane to make it hydrophobic. As can be seen, however, droplets 302 are in an ‘impaled state’ in which they exist or reside in regions between the square posts 304, instead of sitting on top of the square posts.

In certain embodiments, surfaces with microstructures that are encapsulated or impregnated with a secondary liquid show a demonstrably enhanced ability to shed droplets that are immiscible with the secondary liquid. Viscosity (e.g., of the secondary liquid) is found to be a critical factor affecting the shedding ability of droplets from these surfaces. In various embodiments, encapsulating or impregnating surfaces with a secondary liquid dramatically enhances the shedding rate of the condensed phase from the condensing surface. This enhancement may be achieved through proper choice of a secondary liquid and/or designing a surface texture for a given secondary liquid.

In certain embodiments, the secondary liquid is chosen to provide a surface with enhanced condensation properties. In one embodiment, the choice of the secondary liquid is contingent upon the material properties of the primary condensed phase. For example, desirable traits of the secondary liquid with respect to the condensed phase include immiscibility or partial miscibility (<5% of its weight), non-reactiveness, and/or a lower surface tension. In certain embodiments, a higher surface tension is preferred. In certain embodiments, the partial miscibility of secondary liquid with primary liquid results in change of surface tension of primary liquid such that the spreading coefficient, S, of secondary liquid on primary liquid becomes negative and thereby secondary liquid does not spread over the primary phase, where S is defined according to Equation 2.

S=γ_{wa}−γₒₐ−γ_{ow} (2)

Some examples of such liquids whose spreading coefficient changes upon partial miscibility and which can be used as secondary liquids with respect to water include 1,1-diphenyl-ethane, benzene, ionic liquid (1-butyl-3-methylimidazolium bis(trifluoromethylsulfonyl)imide), etc. For example, pure water has a surface tension of 72 dynes/cm and has positive spreading coefficient (22 dynes/cm) with ionic liquid (1-butyl-3-methylimidazolium bis(trifluoromethylsulfonyl)imide). However addition of 1.3% wt/vol of the said ionic liquid changes the surface tension of water to 42 dynes/cm and the spreading coefficient of ionic liquid (1-butyl-3-methylimidazolium bis(trifluoromethylsulfonyl)imide) on water becomes −8 dynes/cm and so condensed water forms in a dropwise manner on the surface of the said ionic liquid without getting cloaked by it.

It is presently found that surfaces impregnated with low viscosity secondary liquids shed water droplets much faster than those impregnated with high viscosity secondary liquids. For example, in one experiment, a 10 μl droplet deposited on an impregnated surface with secondary liquid having low viscosity (10 cSt) shed droplets at velocities that were about 100 times the droplet shedding velocity of an impregnated surface with secondary liquid having high viscosity (1000 cSt). In this example, both surfaces were inclined at the same angle (about 30° from horizontal). In certain embodiments, the viscosity of the secondary liquid is from about 10 cSt to about 1000 cSt. For growth of condensation on the surface, however, the choice of secondary liquid may also require consideration of additional parameters of the secondary liquid, such as surface tension.

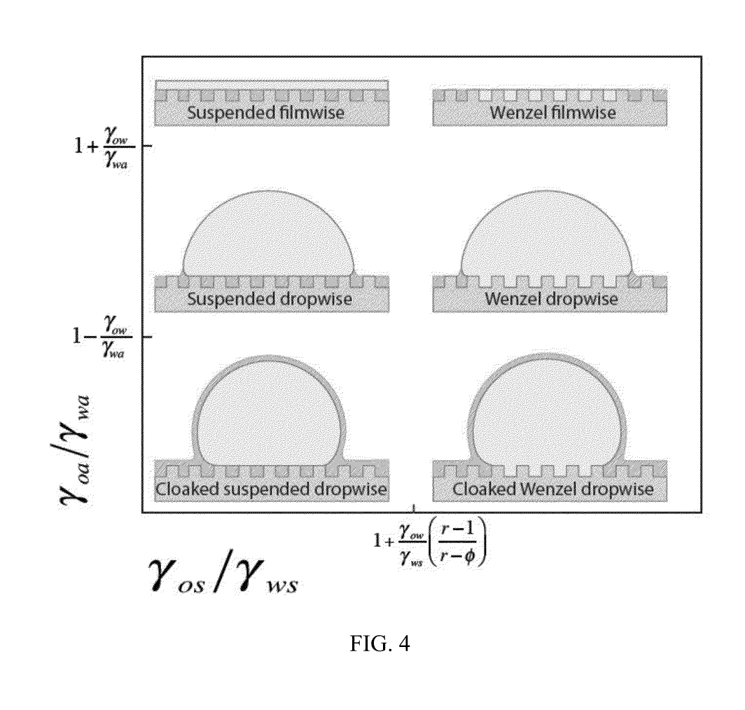

Referring to FIG. 4, a mathematical map has been developed to guide the choice of a secondary liquid to be used with a particular primary liquid on a given solid surface, in certain embodiments. When the ratio of surface energy of encapsulating liquid with respect to solid surface (γₒₛ) to surface energy of condensing phase with respect to solid surface (γ_{ws}) is such that:

γₒₛ/γ_{ws}<[1+(γ_{ow}/γ_{ws})((r−1)/(r−φ))], (3)

it is found that, when introduced to the encapsulated surface, the primary liquid remains suspended on top of the encapsulated surface and does not displace the secondary (encapsulating) liquid. In Equation (3), r is the is the ratio of the actual area to the projected area, and φ is the area fraction of the solid that touches the condensate. However, when the following holds:

γₒₛ/γ_{ws}>[1+(γ_{ow}/γ_{ws})((r−1)/(r−φ))], (4)

it is found that the primary liquid displaces the secondary liquid and gets pinned on the solid surface. Similarly, if the surface energies of secondary liquid and primary liquid are such that:

γₒₐ/γ_{wa}<[1−γ_{ow}/γ_{wa}], (5)

then it is found that the secondary liquid will spread on the condensing primary liquid, thereby cloaking it. Furthermore, when the following holds:

γₒₐ/γ_{wa}>[1−γ_{ow}/γ_{wa}], (6)

the secondary liquid cannot cloak the primary liquid. Additionally, it is also beneficial that the primary phase does not spread on top of the secondary film in form of filmwise condensation. For this, the secondary liquid should be chosen such that the surface energies of the secondary and primary liquid satisfy the following:

γₒₐ/γ_{wa}<[1+γ_{ow}/γ_{wa}]. (7)

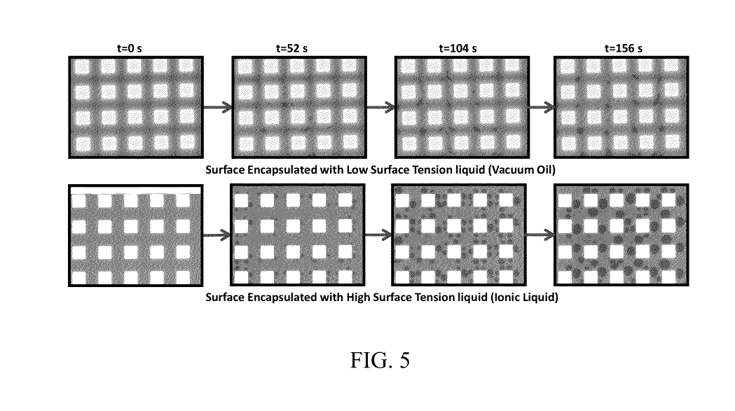

Referring to FIG. 5, the condensation process may differ significantly on surfaces encapsulated or impregnated with secondary liquids having different surface tensions and similar viscosities. In the top row of images of FIG. 5, the depicted surface is impregnated with vacuum oil (KRYTOX 1506), which has a surface tension of 17 dynes/cm at 25° C., while its spreading coefficient, S in Equation (2), is 6 dynes/cm. In the bottom row of images, the depicted surface is impregnated with ionic liquid (1-butyl-3-methylimidazolium bis(trifluoromethylsulfonyl)imide), which has a surface tension of 37 dynes/cm at 25° C., while its spreading coefficient in water is −8 dynes/cm as mentioned above. The bright white square spots shown in the images are 10 μm posts, spaced 10 μm apart. The dark black spots shown in figure are water droplets condensing on the surface. Each of these images was taken at the same magnification and under identical conditions (i.e., pressure of about 800 Pa, and temperature of about 3.7° C.) inside the ESEM. As depicted, considerably more condensation was observed on the surface impregnated with the liquid that has negative spreading coefficient with respect to water than on the surface impregnated with liquid that has positive spreading coefficient with respect to water.

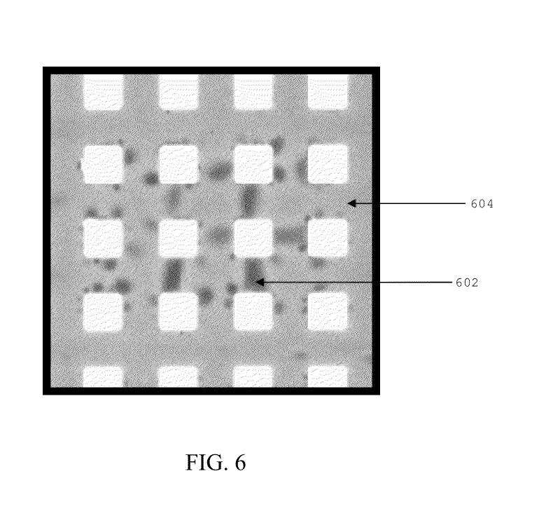

In certain embodiments, dropwise condensation is maximized through the use of a secondary liquid that has a relatively high surface tension. In one embodiment, compared to the surface tension of the condensed phase, the surface tension of the secondary liquid is from about 30% to about 95% of the surface tension of the condensed phase, or preferably from about 33% to about 67% of the surface tension of the condensed phase. For example, when the condensed phase is water (surface tension of about 73 dynes/cm), the surface tension of the secondary liquid is preferably from about 24 dynes/cm to about 49 dynes/cm. In certain embodiments, choosing a secondary liquid with a much lower surface tension than the primary condensed phase may cause the macroscopic contact angle made by droplets of the condensed phase to increase, thereby increasing droplet mobility. However, referring to FIG. 6, the much lower surface tension of the secondary liquid may cause the secondary liquid 602 to climb upon the condensed phase 604 and cover it because the spreading coefficient, S in Equation (2), of the secondary liquid on primary phase may be positive, thereby acting as a barrier against the condensation process. In one embodiment, this barrier is overcome or minimized by choosing a secondary liquid with a higher surface tension. In other words, a secondary liquid with a higher surface tension may be less likely to cover the condensed phase to act as a barrier to condensation and/or condensation heat transfer. In another embodiment, this barrier is overcome or minimized by choosing a secondary liquid which has partial miscibility with the primary phase such that this partial miscibility reduces the surface tension of the primary phase and as a result the spreading coefficient becomes negative.

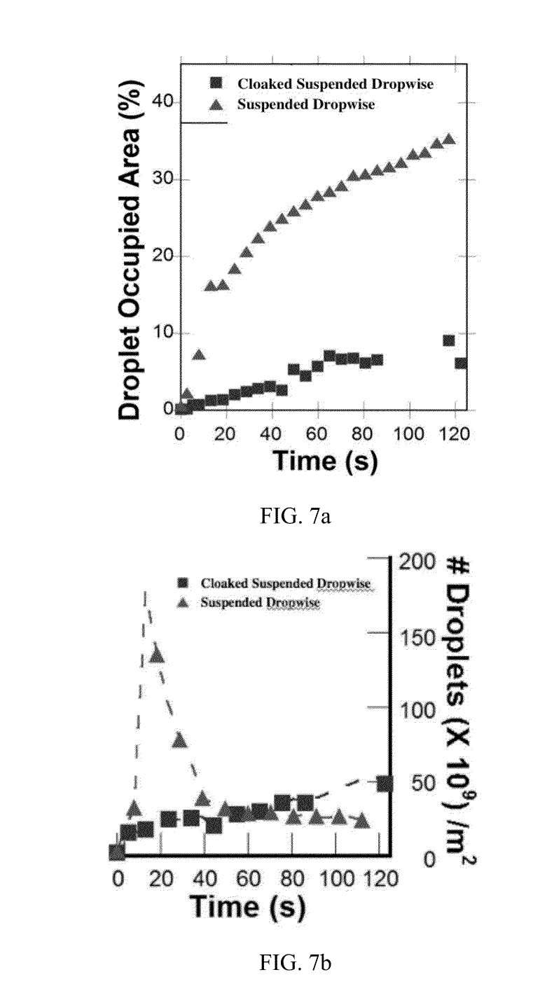

Referring to FIGS. 7a and 7b, experiments were performed to investigate droplet growth of a condensed phase (e.g., water) on surfaces impregnated with secondary liquids having different surface tensions. One of the secondary liquids was the ionic liquid that has negative spreading coefficient with water (−8 dynes/cm). The other secondary liquid was the vacuum oil having a low surface tension and having a positive spreading coefficient with water (6 dynes/cm). Both of these secondary liquids have nearly identical viscosities and also have surface tensions that are lower than the surface tension of the condensed phase (i.e., water, surface tension=72 dynes/cm at 25° C.). However, the growth rate of water droplets for negative spreading coefficient liquid is much more than growth rate of water droplets on positive spreading coefficient liquid, as is signified by the droplet occupied area (FIG. 7a). The decrease in condensation observed in the case of vacuum oil may be attributed to the formation of a film around the condensed phase (water droplet) during the condensation process. This is attributed as cloaked suspended dropwise condensation in the plot, in accordance with the designation used in the regime map (FIG. 4). In one embodiment, the cloaked suspended dropwise condensation is also marked by decrease in formation of new nucleation sites for water to condense and also inhibits coalescence between water droplets, leading to a significantly lower condensation rate, as depicted in FIG. 7b in form of number of droplets per unit area with time.

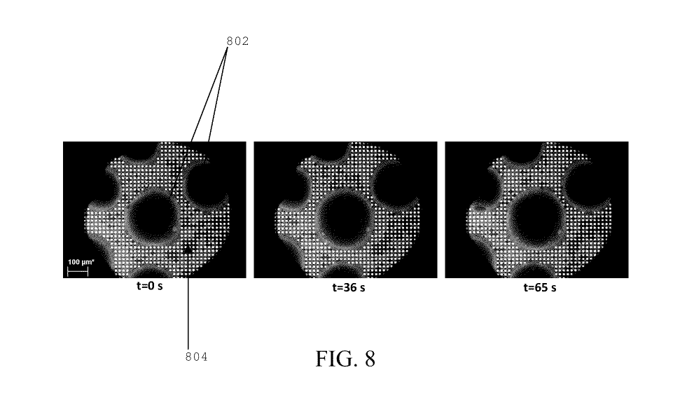

Although a secondary liquid may replace air beneath a microstructure and thereby enhance shedding by preventing a droplet from reaching the Wenzel regime, a large droplet formed through condensation may still show low mobility on a micro-textured surface. For example, FIG. 8 includes a sequence of images of droplets 802 on a surface textured with plain microposts 804, in accordance with an embodiment of the invention. Although use of the secondary liquid diminishes the contact region between the solid surface and the condensed phase (e.g., the droplets are not in the complete Wenzel regime), large droplets may still remain in a pinned state on the surface.

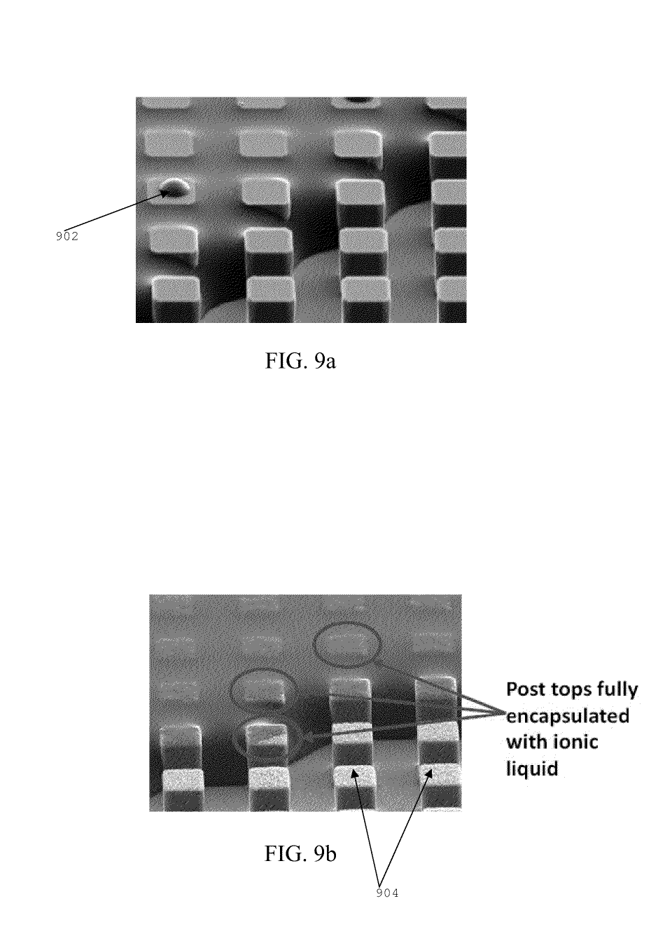

Referring to FIG. 9a, in certain embodiments, low mobility of condensed droplets on a liquid-impregnated surface results from droplet pinning on the microstructures where the secondary liquid is absent 902. However, it is presently found that that this pinning behavior may be dramatically diminished by introducing another level of hierarchical structures upon the pre-existing microstructures on the surface. As an example, referring to FIG. 9b, adding nano-textures on plain square posts 904 may result in a secondary liquid wetting the entire post due to very large forces of capillary pressure.

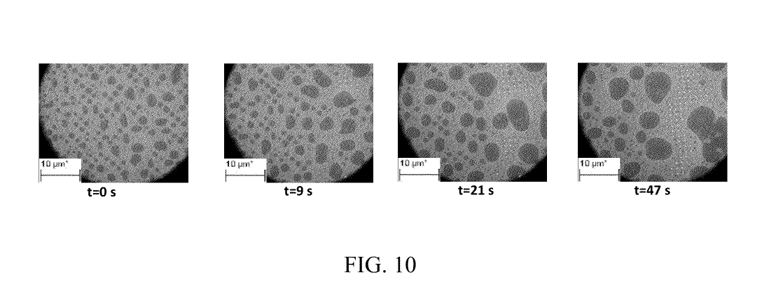

FIG. 10 includes a sequence of photographs showing the influence on condensation produced by introduction of another level of hierarchy upon a micro-textured surface, in accordance with certain embodiments. In the depicted example, the introduction of nano-textures on square microposts resulted in complete encapsulation of the microposts by the ionic liquid, thereby eliminating regions that previously acted as points of adhesion between the primary condensed phase (water) and the condensing surface. The depicted droplets show very high mobility and even microscopic droplets move rapidly along the surface.

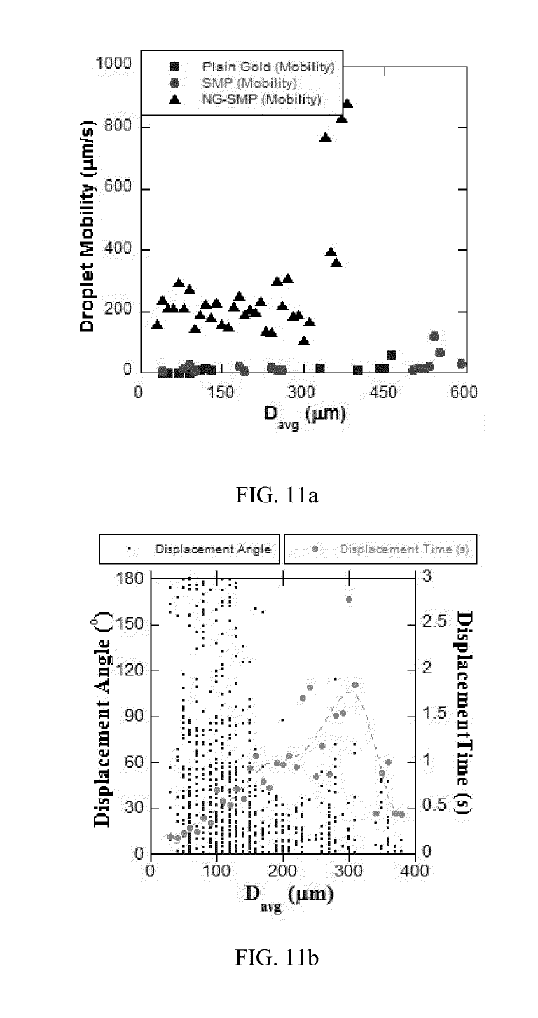

Referring to FIGS. 11a and 11b, in one experiment, mobilities of condensed water droplets were measured on nano-textured microposts, and very high shedding rates were observed. It was found that droplets with sizes smaller than a capillary length of water (about 2.7 mm) can move on these surfaces at velocities of about 0.2 to 2 mm/s. From FIG. 11a, it is shown the droplet mobility on gold surfaces is ˜0 μm/s, and on a micro-textured surface encapsulated with liquid having negative spreading coefficient with water, the droplet mobility 20-50 μm/s. However, upon adding nano-textures on the square microposts and encapsulating the said surface with the liquid having negative spreading coefficient with water, even 30 micron sized droplets can move at speeds ˜200 μm/s. Further, the mobility of droplets on the encapsulated nano-textured microposts is unaffected by gravitational forces as they can move in directions against that of gravity (FIG. 11b).

In certain embodiments, this shedding effect is amplified or improved by increasing the post-spacing between the micropost arrays, for a given post size, and/or by decreasing the post-size, for a given array area. For example, decreasing the ratio of exposed texture surface area to exposed surface area of the encapsulated fluid may increase the shedding velocity of droplets. Similar effects on shedding behavior of condensed droplets are observed on nano-textured microposts fully encapsulated by the ionic liquid, with different post spacings.

In certain embodiments, various criteria for the solid surface and the secondary liquid provide optimal droplet shedding. For example, both the solid surface and the secondary liquid preferably have a lower surface energy than the surface energy of the condensing liquid. Also, the solid surface preferably includes a matrix of features spaced sufficiently close to provide a stable containment or impregnation of liquid therebetween or therewithin. Further, in one embodiment, an amount of roughness required to stably contain a liquid depends on the wettability of that liquid on a chemically identical smooth surface. For example, if the liquid forms a zero contact angle on the smooth surface, then that liquid may form a stable film, even without textures. However, textures may still provide additional stability to the film. Furthermore, as previously discussed, the secondary liquid surface tension is preferably sufficiently low relative to the condensing phase, so that the secondary liquid does not spread over the condensed phase.

In certain embodiments, when the condensing phase is water, suitable secondary liquids include KRYTOX-1506, ionic liquid (e.g., BMI-IM), tetradecane (γ=26.86 dynes/cm), pentadecane (γ=27.07 dynes/cm), cis-decalin (γ=32.2 dynes/cm), α-bromonapthalene (γ=44.4 dynes/cm), diiodomethane (γ=50.8 dynes/cm), EMI-Im (C₈H₁₁F₆N₃O₄S₂) (γ=41.6 Dyne/cm), α-chloronapthalene (γ=41.8 dynes/cm), ethyl oleate (γ=31.0 dynes/cm), o-bromotoluene (γ=41.5 dynes/cm), Phenyl Mustard Oil (γ=36.16 dynes/cm), and the like. The condensing phase may be any material capable of condensing on a surface. For example, the condensing phase may be water, alcohol, mercury, gallium, a refrigerant, and mixtures thereof.

In certain embodiments, the free energy, AG, of a system involving condensation growth via heterogeneous nucleation is given as follows:

$$Δ G = [ - \frac{4 π {r}^{3} {n}_{L} k T}{3} ln ( \frac{p}{{p}_{∞}} ) + 4 π {r}^{2} {σ}_{LV} ] f ( m ) , \\ where f ( m ) = \frac{( {m}^{3} - 3 m + 2 )}{4} \qquad ( 8 )$$

where r is droplet radius, n_{L} is number of condensing droplets on the substrate (solid surface) per unit volume of liquid, p is vapour pressure (partial pressure), p_{∞} is saturation vapour pressure at temperature T, σ_{L,V} is liquid-vapour interfacial energy, and k is Boltzmann's constant. The parameter m is the ratio of the interfacial energies given by m=(σ_{SV}−σ_{SL})/σ_{LV}, where σ_{SV}, σ_{SL}, are, respectively, the substrate-vapour interfacial energy and the substrate-liquid interfacial energy.

For such systems, clusters of water molecules gathered together under random thermal motion may need to reach a critical size to sustain growth. The free energy barrier, ΔG*, to the heterogeneous nucleation of an embryo of critical size on a flat surface, and the corresponding nucleation rate are expressed as

$$Δ {G}^{*} = \frac{π {σ}_{LV} {r}^{* 2}}{3} ( 2 - 3 m + {m}^{3} ) ; \\ J = {J}_{o} exp ( - Δ {G}^{*} / k T ) \qquad ( 9 )$$

where r* is critical radius given in equation (10) below, J is nucleation rate (#/(sec*m³)), and Jₒ is Nucleation Rate Constant (#/(sec*m³)).

The parameter m is the ratio of the interfacial energies given by m=(σ_{SV-σ}_{SL})σ_{LV}, where σ_{SV}, σ_{SL}, are respectively the substrate-vapour and substrate-liquid interfacial energies. The critical radius can then be defined by the Kelvin equation

$$ln ( \frac{p}{{p}_{∞}} ) = \frac{2 {σ}_{LV}}{{n}_{L} k T {r}^{*}} . \qquad ( 10 )$$

Referring to Eq. (9), the energy barrier may increase with increasing contact angle. Consequently, a higher degree of subcooling may be required at a given pressure to overcome this barrier on superhydrophobic surfaces.

In various instances, nucleation experiments on solids have demonstrated much lower energy barriers to nucleation than those predicted by Eq. (9). While not wishing to be bound by a particular theory, this is likely due to nanoscale heterogeneity and roughness, as high surface energy patches of a surface and nanoscale concavities can act as nucleation sites. However, there may be very low control on initiation of condensation on solid substrates. In one embodiment, spatial control of surface energy is one of the methods for controlling preferential nucleation.

Compared to solid substrates, liquids surfaces are commonly very smooth and homogeneous, and nucleation of water on liquids may therefore agree well with classical theory. Consequently, in an absence of nucleation sites, hydrophobic liquids may present a much higher energy barrier to frost nucleation or condensation, than the energy barrier presented by solids. Therefore, impregnating a liquid within the textures of a superhydrophobic surface may prevent nucleation in these regions.

In certain embodiments, nucleation in encapsulated liquids is controlled by passage of electrical current. For condensation on aerosols, the free energy barrier may be dramatically lowered if aerosol particles have charge upon them. The free energy, as given in Eq. (8), in the case of ions or charged particles may be expressed as

$$Δ G = [ - \frac{4 π {r}^{3} {n}_{L} k T}{3} ln ( \frac{p}{{p}_{∞}} ) + 4 π {r}^{2} {σ}_{LV} ] f ( m ) + \frac{{q}^{2}}{2} ( 1 - \frac{1}{ɛ} ) ( \frac{1}{r} - \frac{1}{{r}_{o}} ) . \qquad ( 11 )$$

where q is the unit charge, ∈ is the dielectric constant, and rₒ is the radius of the core ion.

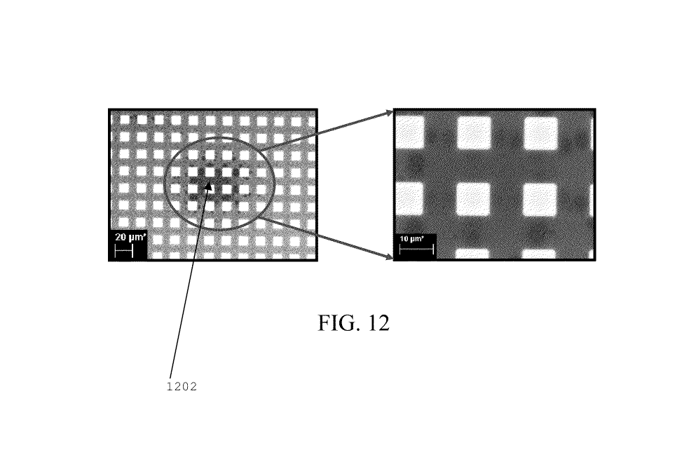

In one embodiment, nucleation in encapsulated liquids is controlled by subjecting the liquids to an electric charge. As an example, referring to FIG. 12, when electric current is passed through a micro-textured surface with an encapsulated or secondary liquid, nucleation sites may be created preferentially, only under the region where the current is being passed. In the depicted experiment, the electric current was concentrated upon a very small region 1202 (about 40×40 μm²), inside the ESEM. When magnification was decreased, it was observed that condensation had taken place only under the region that was exposed to the electron beam.

Further, condensation can be achieved in regions where the electron flux is passed, under thermodynamic conditions much below those predicted by theoretical estimates. For example, the saturation temperature at a pressure of 800 Pa is about 3.6° C. However, in one experiment, in a region exposed to electron flux, condensation was found to take place even at 5.4° C. In the absence of electron flux, the experiment showed that condensation was not initiated on surfaces with nano-textured micropost arrays, even when the temperature of the sample was about 0° C.

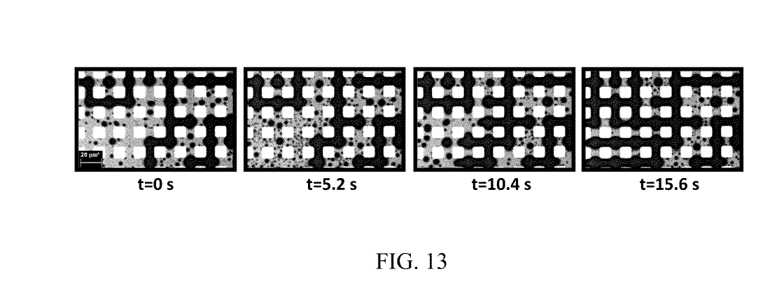

Referring to FIG. 13, in another experiment, water remained a liquid even at sub-zero temperatures, indicating that nucleation of water to ice was suppressed on the impregnated surface. Although the sample temperature in the experiment was −4° C., the droplets did not show characteristics of ice. Instead, the growth and coalescence behavior observed had the same attributes as observed for liquid water condensation at higher temperatures.

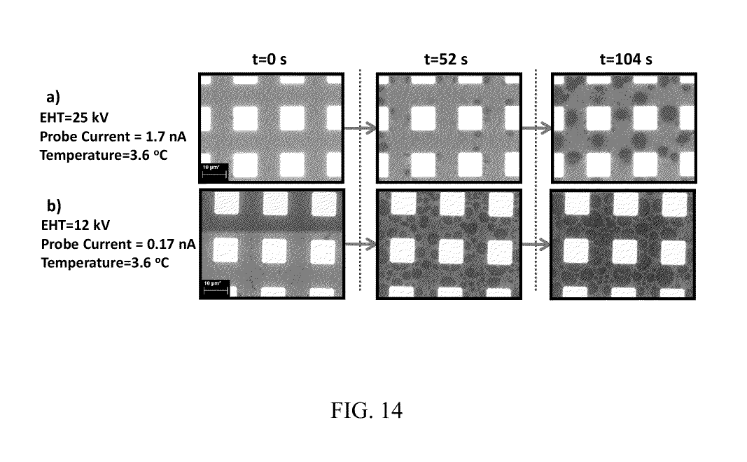

In some embodiments, nucleation sites are dramatically altered by controlling (i) a depth through which the electron fluxes are passed through the sample and/or (ii) the amount of the electron flux. For example, in one set of experiments, the depth of the electron flux in a sample was increased by increasing the beam voltage of an electron gun in an ESEM, and the electron flux was increased by increasing the beam current of the electron gun. Referring to FIG. 14a, when the condensing surface (with secondary liquid) is exposed to conditions that result in deeper penetration of electrical charges in the sample, condensation occurs preferentially near the microposts, with or without nano-textures. Referring to FIG. 14b, however, when the sample is exposed to conditions that result in electrical charges dispersed closer to the interface between the secondary liquid and the condensing species, the number of nucleation sites is dramatically enhanced and this enhances condensation further. In FIGS. 14a and 14b, “EHT” refers to Electron High Tension, which controls the amount of voltage applied inside a Scanning Electron Microscope. In certain embodiments, the control of nucleation initiation and condensation rate is done over a broad range of applied voltages (e.g., 1-300 kV) and beam currents (e.g., at least 10 picoAmperes), which may depend upon the tool used to generate the electrical conditions. The maximum values of applied voltages and beam current are decided by the limits at which dielectric breakdown of the secondary liquid may occur.

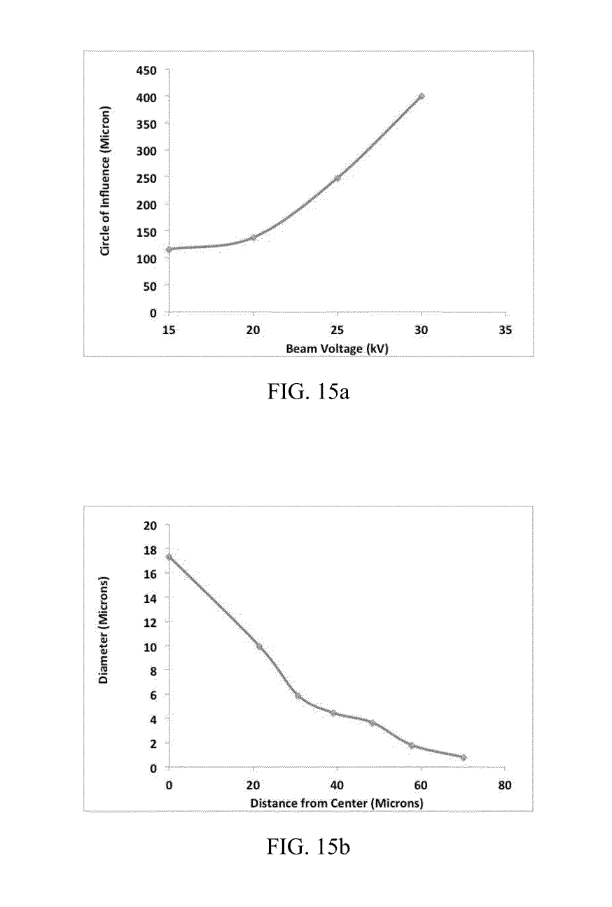

In some embodiments, the effect of an imposed electric flux on a given area spreads to much larger area and condensation may be observed in these larger areas. Referring to FIG. 15a, the effect of a focused beam at a spot is given in terms of circle of influence that denotes the region that is actually affected by an imposed electric flux. For example, in one set of experiments, the beam voltage of an electron gun in an ESEM was increased while the electron beam was concentrated upon a very small region (about 10×10 μm²), and its effect was recorded after 10 minutes of exposure. Referring to FIG. 15a, condensation of water was observed to occur in much larger sections (about 400×400 μm² at beam voltage of 30 kV). In certain embodiments, imposed electric flux may result in dispersal of charge within the encapsulating liquid that may be dependent upon time. Referring to FIG. 15b, the electron beam was concentrated upon a very small region (about 10×10 μm²) for a period of five minutes and the beam voltage was 15 kV while the beam current was 1.7 nA. Condensation was observed to take place in a larger section (about 70×70 μm²) and the size of condensed droplets was found to almost linearly decrease away from the point where the electron beam was focused. This signifies that the electric charges disperse inside the encapsulating liquid with time. In certain embodiments, this phenomenon can be used to design condensers where electrodes can be placed at known distances from each other and each electrode may be supplied with electricity to create artificially disseminate charges in the encapsulating liquids.

The apparatus, articles, methods, and processes described herein provide several advantages over previous superhydrophobic surfaces. For example, the approach yields surfaces that can minimize and eliminate pinning of droplets by preventing freshly nucleated droplets from attaining a Wenzel state. The approach also enables enhancement of shedding rate of the condensed phase, and droplets with sizes less than the capillary length (λ_{c}=\sqrt{γ/ρg}) may be shed easily. Also, previous superhydrophobic surfaces suffer from durability issues due to brittle, high aspect ratio nanostructures. With the approach of impregnating surfaces with secondary liquids, however, even low aspect ratio microscale features may be sufficient for many applications, and can therefore be much more mechanically durable than previous superhydrophobic surfaces, with similar drop shedding properties. Further, with the approach described herein, even normal or typical surface textures (i.e., textures not prepared by specialized fabrication methods) may be converted into surfaces that can shed water easily.

The approach described herein also advantageously enables control over thermodynamic conditions leading to condensation, through the use of electrical charges or fluxes. Thus, nucleation initiation temperature, rate of condensation, and the like, may be controlled by subjecting a sample to an electron flux or charge. The electric flux or electric field may be used to direct droplets in a way that enhances coalescence and shedding. For example, very small droplets (e.g., <1 mm) may be forced to shed through the use of electric fields.

The apparatus, articles, methods, and processes described herein may be used in a wide variety of applications where control over droplet condensation is desirable. For example, using the approach described herein, manufacturers of steam turbines may reduce moisture-induced efficiency losses caused by water droplets, entrained in steam, impinging on turbine blades and forming films, thereby reducing power output. Likewise, condensers in power and desalination plants may use the approach to promote dropwise condensation heat transfer. In some embodiments, anti-icing and anti-fogging devices may incorporate the surfaces described herein to suppress condensation on their surfaces. With respect to aircraft and wind turbines, these approaches may be used to reduce the contact time of water droplets impinging upon surfaces. This may be desirable to prevent droplets them from freezing and, for example, degrading aerodynamic performance. In industries that manufacture or utilize atomizers, the ability of the surfaces described herein to break up droplets can be used to create new atomizers for applications in engines, agriculture, and pharmaceutical industries. In various embodiments, these approaches may be utilized in buildings or other structures to prevent moisture from forming on surfaces, interior panels, and the like, thereby minimizing fungi or spore formation.

The solid substrate in the embodiments described herein may include, for example, any intrinsically hydrophobic, oleophobic, and/or metallophobic material or coating. For example, the solid may include: hydrocarbons, such as alkanes, and fluoropolymers, such as teflon, trichloro(1H,1H,2H,2H-perfluorooctyl)silane (TCS), octadecyltrichlorosilane (OTS), heptadecafluoro-1,1,2,2-tetrahydrodecyltrichlorosilane, fluoroPOSS, and/or other fluoropolymers. Additional possible materials or coatings for the solid include: ceramics, polymeric materials, fluorinated materials, intermetallic compounds, and composite materials. Polymeric materials may include, for example, polytetrafluoroethylene, fluoroacrylate, fluoroeurathane, fluorosilicone, fluorosilane, modified carbonate, chlorosilanes, silicone, polydimethylsiloxane (PDMS), and/or combinations thereof. Ceramics may include, for example, titanium carbide, titanium nitride, chromium nitride, boron nitride, chromium carbide, molybdenum carbide, titanium carbonitride, electroless nickel, zirconium nitride, fluorinated silicon dioxide, titanium dioxide, tantalum oxide, tantalum nitride, diamond-like carbon, fluorinated diamond-like carbon, and/or combinations thereof. Intermetallic compounds may include, for example, nickel aluminide, titanium aluminide, and/or combinations thereof.

The matrix of features described herein are physical textures or surface roughness. The features may be random, including fractal, or patterned. In certain embodiments, the features are micro-scale or nano-scale features. For example, the features may have a length scale L (e.g., an average pore diameter, or an average protrusion height) that is less than about 100 microns, less than about 10 microns, less than about 1 micron, less than about 0.1 microns, or less than about 0.01 microns. In certain embodiments, the features include posts or other protrusions, such as spherical or hemispherical protrusions. Rounded protrusions may be preferable to avoid sharp solid edges and minimize pinning of liquid edges. The features may be introduced to the surface using any conventional method, including mechanical and/or chemical methods such as lithography, self-assembly, and deposition, for example.

The impregnating liquid in the embodiments described herein may be, for example, oil-based or water-based (i.e., aqueous). In certain embodiments, the impregnating liquid is an ionic liquid (e.g., BMI-IM). Other examples of possible impregnating liquids include hexadecane, vacuum pump oils (e.g., FOMBLIN® 06/6, KRYTOX® 1506) silicon oils (e.g., 10 cSt or 1000 cSt), fluorocarbons (e.g., perfluoro-tripentylamine, FC-70), shear-thinning fluids, shear-thickening fluids, liquid polymers, dissolved polymers, viscoelastic fluids, and/or liquid fluoroPOSS. In certain embodiments, the impregnating liquid is (or comprises) a liquid metal, a dielectric fluid, a ferro fluid, a magneto-rheological (MR) fluid, an electro-rheological (ER) fluid, an ionic fluid, a hydrocarbon liquid, and/or a fluorocarbon liquid. In one embodiment, the impregnating liquid is made shear thickening with the introduction of nano particles. A shear-thickening impregnating liquid may be desirable for preventing impalement and resisting impact from impinging liquids, for example.

To minimize evaporation of the impregnating liquid from the surface, it is generally desirable to use impregnating liquids that have low vapor pressures (e.g., less than 20 mmHg, less than 10 mmHg, less than 5 mmHg, less than 1 mmHg, less than 0.1 mmHg, less than 0.001 mmHg, less than 0.00001 mmHg, or less than 0.000001 mmHg). In certain embodiments, the impregnating liquid has a freezing point of less than −20° C., less than −40° C., or about −60° C. In certain embodiments, the surface tension of the impregnating liquid is about 15 mN/m, about 20 mN/m, or about 40 mN/m. In certain embodiments, the viscosity of the impregnating liquid is from about 10 cSt to about 1000 cSt.

The impregnating liquid may be introduced to the surface using any conventional technique for applying a liquid to a solid. In certain embodiments, a coating process, such as a dip coating, blade coating, or roller coating, is used to apply the impregnating liquid. In other embodiments, the impregnating liquid may be introduced and/or replenished by liquid materials flowing past the surface (e.g., in a pipeline). After the impregnating liquid has been applied, capillary forces hold the liquid in place. Capillary forces scale roughly with the inverse of feature-to-feature distance or pore radius, and the features may be designed such that the liquid is held in place despite movement of the surface and despite movement of air or other fluids over the surface (e.g., where the surface is on the outer surface of an aircraft with air rushing over, or in a pipeline with oil and/or other fluids flowing therethrough). In certain embodiments, nano-scale features are used (e.g., 1 nanometer to 1 micrometer) where high dynamic forces, body forces, gravitational forces, and/or shearing forces could pose a threat to remove the liquid film, e.g., for surfaces used in fast flowing pipelines, on airplanes, on wind turbine blades, etc. Small features may also be useful to provide robustness and resistance to impact.

U.S. patent application Ser. No. 13/302,356, filed Nov. 22, 2011, entitled, “Liquid-Impregnated Surfaces, Methods of Making, and Devices Incorporating the Same,” Attorney Docket No. MIT-206, is incorporated herein by reference in its entirety. U.S. Provisional Patent Application No. 61/515,395, filed Aug. 5, 2011, is also incorporated herein by reference in its entirety.

### EQUIVALENTS

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. An article comprising a liquid-impregnated surface configured to promote or inhibit condensation thereupon and/or shedding of condensate thereupon, said surface comprising a matrix of features on a solid substrate and an impregnating liquid, said features spaced sufficiently close to stably contain an impregnating liquid therebetween or therewithin.

2. The article of claim 1, wherein the impregnating liquid has a surface tension with respect to air, γₒₐ, such that:
(γ_{wa}−γ_{ow})<γₒₐ<(γ_{wa}+γ_{ow})
where γ_{wa} is surface tension of the condensate with respect to air or other surrounding gas, γₒₐ is surface tension of the impregnating liquid with respect to air or other surrounding gas, and γ_{ow} is interfacial tension between the impregnating liquid and the condensate.

3. The article of claim 1, wherein one or more of expressions (a) through (d) holds:
(γ_{wa}−γ_{ow})<γₒₐ<(γ_{wa}+γ_{ow}); (a)
γₒₛ/γ_{ws}<[1+(γ_{ow}/γ_{ws})((r−1)/(r−φ))]; (b)
γₒₐ/γ_{wa}>[1−γ_{ow}/γ_{wa}]; and (c)
γₒₐ/γ_{wa}<[1+γ_{ow}/γ_{wa}], (d)
where γ_{wa} is surface tension of the condensate with respect to air or other surrounding gas, γₒₐ is surface tension of the impregnating liquid with respect to air or other surrounding gas, γ_{ow} is interfacial tension between the impregnating liquid and the condensate, γₒₛ is interfacial tension between the impregnating liquid and the solid substrate, γ_{ws} is interfacial tension between the condensate and the solid substrate, r is ratio of actual surface area of the solid substrate to projected area of the solid substrate, and φ is fraction of the surface area of the solid substrate that touches the condensate.

4. The article of claim 1, wherein all of (a), (b), (c), and (d) holds such that the impregnating liquid does not spread on the condensate, the condensate does not displace the impregnating liquid, and the condensate does not spread on the impregnating liquid in filmwise condensation.

5. The article of claim 1, wherein the surface is configured to promote condensation and/or shedding of condensate thereupon, and wherein the impregnating liquid has a surface tension from about 30% to about 95% of the surface tension of the condensate.

6. The article of claim 5, wherein the impregnating liquid has a surface tension from about 33% to about 67% of the surface tension of the condensate.

7. The article of claim 1, wherein the condensate is water.

8. The article of claim 7, wherein the surface tension of the impregnating liquid is from about 24 dynes/cm to about 49 dynes/cm.

9. The article of claim 1, wherein the impregnating liquid comprises at least one member selected from the group consisting of Krytox-1506, ionic liquid (e.g., BMI-IM), tetradecane, pentadecane, cis-decalin, alpha-bromonaphthalene, alpha-chloronapthalene, diiodomethane, Ethyl Oleate, o-bromotoluene, diiodomethane, tribromohydrin, Phenyl Mustard Oil, Acetylene tetrabromide, and EMI-Im (C₈H₁₁F₆N₃O₄S₂).

10. The article of claim 1, wherein the impregnating liquid has viscosity no greater than about 500 cP.

11. The article of claim 10, wherein the impregnating liquid has viscosity no greater than about 100 cP.

12. The article of claim 11, wherein the impregnating liquid has viscosity no greater than about 50 cP.

13. The article of claim 1, wherein the impregnating liquid has vapor pressure at room temperature no greater than about 20 mm Hg.

14. The article of claim 1, wherein the matrix of features comprises hierarchical structures.

15. The article of claim 14, wherein the hierarchical structures are micro-scale features that comprise nano-scale features thereupon.

16. The article of claim 1, wherein the features have substantially uniform height and wherein the impregnating liquid fills space between the features and coats the features with a layer at least about 5 nm in thickness over the top of the features.

17. The article of claim 1, wherein the features define pores or other wells and wherein the impregnating liquid fills the features.

18. The article of claim 1, wherein the impregnating liquid forms a stable thin film on top of the features.

19. The article of claim 1, wherein the matrix has a feature-to-feature spacing from about 1 micrometer to about 100 micrometers.

20. The article of claim 1, wherein the features comprise at least one member selected from the group consisting of posts, particles, nanoneedles, nanograss, and random geometry features.

21. The article of claim 1, wherein the article comprises a plurality of spaced-apart electrodes configured for imposing an electric field or an electric flux to the liquid-impregnated surface.

22. The article of claim 21, wherein the article is a condenser.

23. The article of claim 1, wherein the solid substrate comprises one or more members selected from the group consisting of a hydrocarbon, a polymer, a fluoropolymer, a ceramic, glass, fiberglass, and a metal.

24. The article of claim 1, wherein the solid substrate is a coating.

25. The article of claim 1, wherein the solid substrate is intrinsically hydrophobic.

26. A method for enhancing condensation and/or shedding of a condensate (primary liquid) upon a surface, the method comprising impregnating the surface with an impregnating liquid (secondary liquid), said surface comprising a matrix of features on a solid substrate and the impregnating liquid, said features spaced sufficiently close to stably contain the impregnating liquid therebetween or therewithin.

27. The method of claim 26, wherein the surface is configured and/or the impregnating liquid is chosen such that one or more of expressions (a) through (d) holds:
(γ_{wa}−γ_{ow})<γₒₐ<(γ_{wa}+γ_{ow}); (a)
γₒₛ/γ_{ws}<[1+(γ_{ow}/γ_{ws})((r−1)/(r−φ))]; (b)
γₒₐ/γ_{wa}>[1−γ_{ow}/γ_{wa}]; and (c)
γₒₐ/γ_{wa}<[1+γ_{ow}/γ_{wa}], (d)
where γ_{wa} is surface tension of the condensate with respect to air or other surrounding gas, γₒₐ is surface tension of the impregnating liquid with respect to air or other surrounding gas, γ_{ow} is interfacial tension between the impregnating liquid and the condensate, γₒₛ is interfacial tension between the impregnating liquid and the solid substrate, γ_{ws} is interfacial tension between the condensate and the solid substrate, r is ratio of actual surface area of the solid substrate to projected area of the solid substrate, and φ is fraction of the surface area of the solid substrate that touches the condensate.

28. The method of claim 27, wherein all of (a), (b), (c), and (d) holds such that the secondary liquid does not spread on the primary liquid, the primary liquid does not displace the secondary liquid, and the primary liquid does not spread on the secondary liquid in filmwise condensation.

29. The method of claim 26, wherein the secondary liquid is chosen such that the spreading coefficient S of the secondary liquid on the primary liquid is negative. where S=γ_{wa}−γₒₐ−γ_{ow}, where γ_{wa} is surface tension of the condensate with respect to air or other surrounding gas, γₒₐ is surface tension of the impregnating liquid with respect to air or other surrounding gas, and γ_{ow} is interfacial tension between the impregnating liquid and the condensate.

30. The method of claim 29, wherein the secondary liquid is chosen such that the secondary liquid has partial miscibility with the primary liquid such that the surface tension of a primary phase consisting essentially of the primary liquid is reduced and the spreading coefficient S is negative.

31. The method of claim 26, further comprising applying an electric field or electric flux to at least a portion of the surface.

32. The method of claim 31, comprising applying the electric field or electric flux via a plurality of spaced-apart electrodes, wherein the electrodes are spread apart to disseminate a charge throughout the impregnating liquid.

33. The method of claim 26, wherein the surface is the liquid-impregnated surface of the article of any one of claims 1-25.
